(19) United States
(12) Patent Application Publication
(10) Pub. No.: US 2007/0170150 A1
(43) Pub. Date: Jul. 26, 2007

(54) Process for removing a layer

(76) Inventors: Georg Bostanjoglo, Berlin (DE); Stefan Krause, Mulheim an der Ruhr (DE); Michael Ott, Mulheim an der Ruhr (DE); Ralph Reiche, Berlin (DE); Jan Steinbach, Berlin (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/587,702

(22) PCT Filed: Jan. 17, 2005
(86) PCT No.: PCT/EP05/00405

§ 371 Date: Jul. 27, 2006

(30) Foreign Application Priority Data
Jan. 30, 2004 (EP) 04002158.6

(51) Int. Cl. C23G 1/00; B44C 1/22; C23F 1/00

(52) U.S. Cl. 216/62; 134/2

(57) ABSTRACT

Components comprising corrosion products are often reused, in which case the corrosion product has to be removed. According to the prior art, this takes a very long time since the reaction times with the corrosion product are often very long. According to the invention, the corrosion product is pretreated in order to produce a larger attackable surface area, so that the corrosion product can be removed more quickly.

### CROSS REFERENCE TO RELATED APPLICATIONS

This application is the US National Stage of International Application No. PCT/EP2005/000405, filed Jan. 17, 2005 and claims the benefit thereof. The International Application claims the benefits of European Patent application No. 04002158.6 filed Jan. 30, 2004. All of the applications are incorporated by reference herein in their entirety.

### FIELD OF THE INVENTION

The invention relates to a process for removing a layer as described in the claims.

### BACKGROUND OF THE INVENTION

After they have been used, components, such as for example turbine blades or vanes, have corrosion products, such as for example oxides, sulfides, nitrides, carbides, phosphates, etc. which form a layer. Components of this type, after they have been used, can be reused if, inter alia, the corrosion products have been removed. The complete removal of the corrosion products is effected, for example, by sand-blasting, although this can lead to damage to the substrate.

It is also possible for the component to be completely treated by means of acid stripping or fluoride ion cleaning (FIC). However, this is very time-consuming since the material-removal rates of the corrosion products over the course of time are in some cases too low with respect to the acid or the fluorine and/or fluoride.

U.S. Pat. No. 5,575,858 describes a process for removing a removal region, in particular a corrosion product of a component, in which the removal region is pretreated prior to final cleaning, so as to damage the removal region, so that then the material-removal rate during the final cleaning of the removal region is greater than without the damage to the removal region.

### SUMMARY OF THE INVENTION

Similar processes are disclosed in U.S. Pat. No. 4,439,241, U.S. Pat. No. 5,464,479 and EP 1 013 797. Therefore, the object of the invention is that of providing a process in which the removal of layers on a component is facilitated and therefore takes less time.

The object is achieved by the process as claimed in the claims.

The subclaims list further advantageous measures of the process according to the invention.

The measures listed in the subclaims can be combined with one another in advantageous ways.

### BRIEF DESCRIPTION OF THE DRAWINGS

The invention is explained schematically with reference to the figures, in which

FIG. 1 shows a component with a corrosion product,

FIG. 2 diagrammatically depicts the execution of the process according to the invention,

FIG. 3, 4, 5 show the component after the process according to the invention has been carried out,

FIG. 6 shows a gas turbine,

FIG. 7 shows a combustion chamber,

FIG. 8 shows a turbine blade or vane, and

FIG. 9 shows a steam turbine.

### DETAILED DESCRIPTION OF THE INVENTION

FIG. 1 shows a component 1 which can be treated by the process according to the invention.

The component 1 comprises a ceramic or metallic substrate 4 (base body) which is for example, in particular for turbines, a cobalt-base, iron-base or nickel-base superalloy.

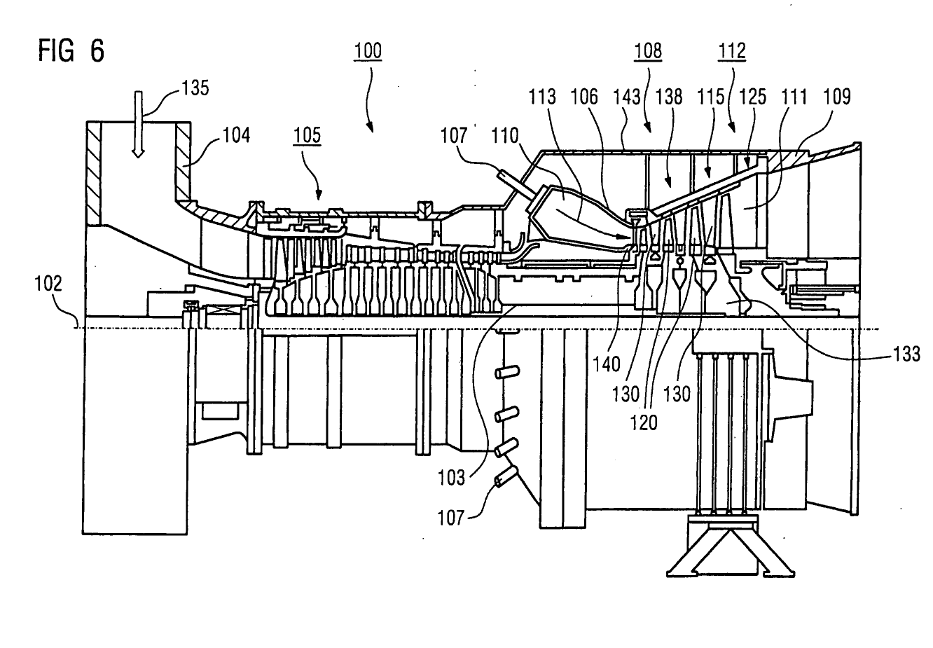

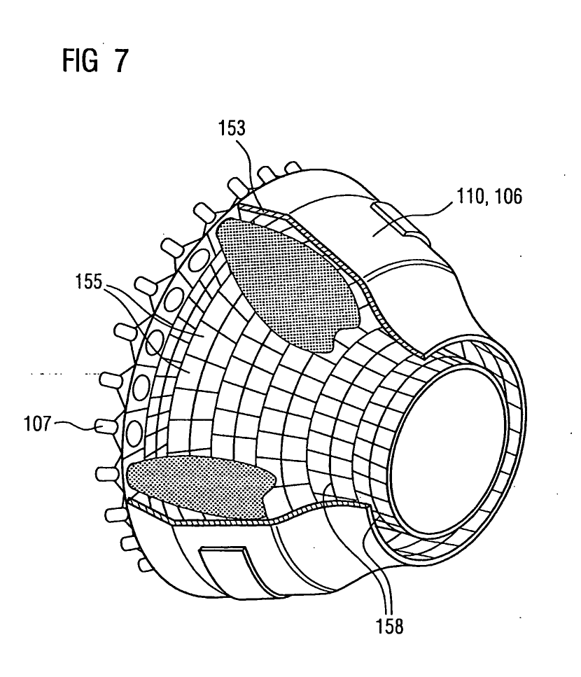

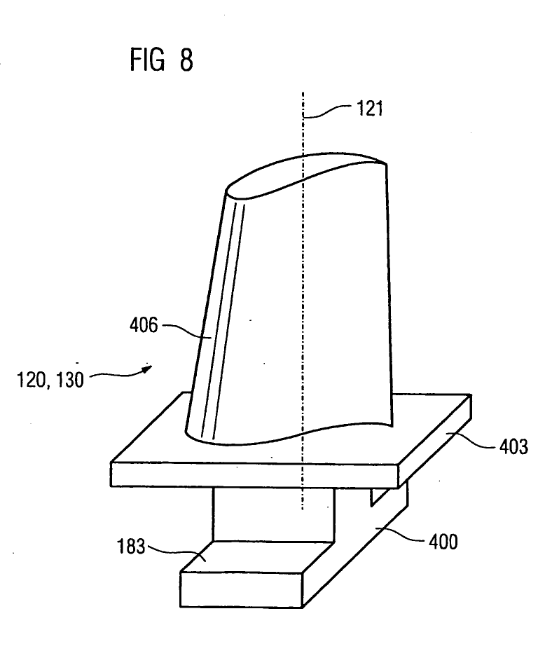

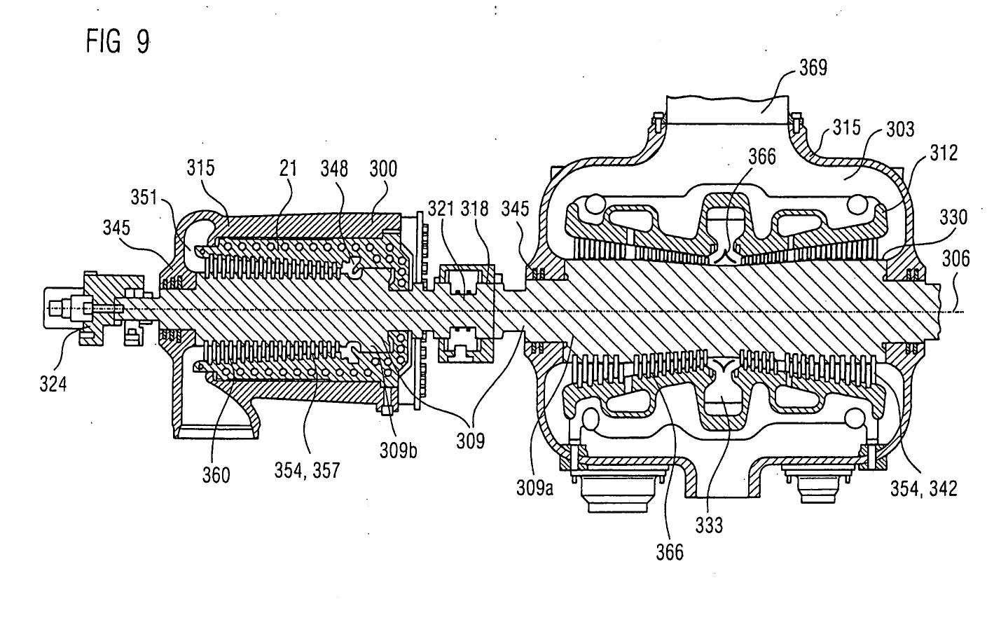

The component 1 is, for example, a guide vane 130 or rotor blade 120 (FIGS. 6, 8) of a gas turbine 100 (FIG. 6), of a steam turbine 300, 303 (FIG. 9) or of an aircraft turbine, a combustion chamber lining 155 (FIG. 7) or another component of a turbine which is exposed to hot gases.

The component 1 may be either newly produced or refurbished. Refurbishment means that components 1, after they have been used, if appropriate have layers (thermal barrier coating) detached and corrosion and oxidation products removed. If appropriate, cracks may also have to be repaired.

A component 1 of this type can then be coated again; this is particularly advantageous because the base body is very expensive.

For use, the component 1 may have at least one ceramic or metallic layer on the surface 13, such as for example an MCrAlX layer and/or a thermal barrier coating resting thereon, which can be roughly removed in a first process step.

The MCrAlX layer may also represent the removal region 10 which is treated by the process according to the invention.

In the text which follows, the removal region 10 is considered to be a corrosion product 10 (corrosion layer 10). However, the removal region 10 may equally be a functional layer without corrosion products.

The removal region 10 may be a metallic and/or ceramic layer, in which case the layer may be metallic and includes corrosion products. The corrosion product 10, for example an oxide, a sulfide, a nitride, a phosphide or a carbide, etc., may be present on a surface 13 of the component 1 or in a crack 7 in the component 1.

The corrosion products 10 have to be removed from the crack 7 or from the surface 13 so that the crack 7 can be filled with a solder or welding material and the surface 13 can be coated again. Corrosion products 10 would otherwise prevent or at least reduce good bonding of the solder or renewed coating.

The corrosion product 10 according to the prior art has a defined material-removal rate (mass per unit time) when it is cleaned for example using the FIC process. However, this material-removal rate is too low and after a certain time may even be zero.

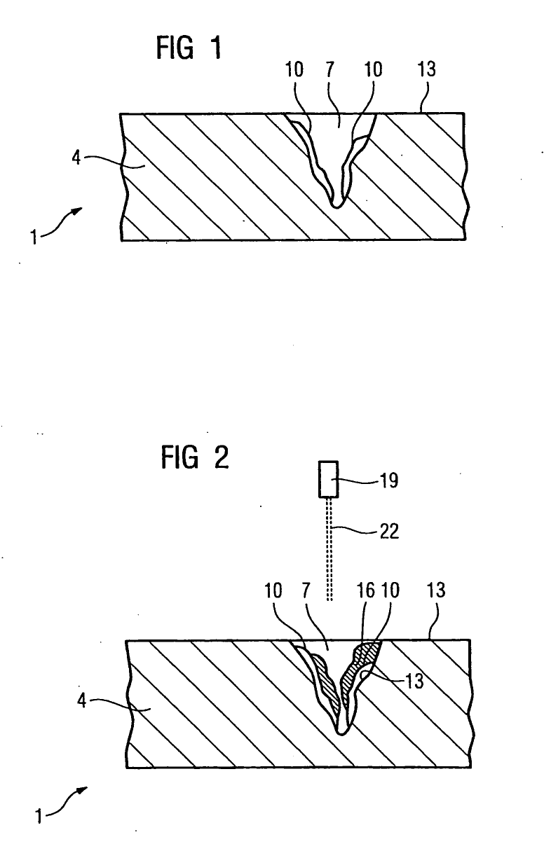

FIG. 2 diagrammatically depicts the execution of the process according to the invention.

By way of example, a material 16, for example a salt 16, which can react chemically with the corrosion product 10 in order to damage the removal region 10, is applied to the corrosion product 10 in order to damage the latter.

The salt used is preferably Na₂SO₄ (sodium sulfate) and/or CoSO₄ (cobalt sulfate). Further salts or combinations are conceivable.

The corrosion products aluminum oxide and/or cobalt oxide and/or titanium oxide of the metals titanium, aluminum and/or cobalt which are contained in the alloy (for example super-alloy) of the substrate 4 can be removed very successfully in particular using these salts.

It is also possible for a fused salt to be applied directly in the crack 7 or to the corrosion product 10 or for the component 1 to be immersed in a fused salt.

It is also possible for the salt to be applied into the crack 7 and to the surface 13 in the form of a slurry. In the case of large-area applications, it is appropriate to lay down a sheet which contains the material 16 or salt 16.

The salt 16 can, for example, be heated, in particular locally, by means of a laser 19 and its laser beams 22, resulting in a chemical reaction of the salt 16 with the corrosion product 10 or a thermal shock.

The heating can also be effected by electromagnetic induction, in particular if the substrate 4 is metallic. The heating of the component 1 can be effected, for example locally, by means of induction or by means of a light source, for example by means of a laser, by the laser 19 radiating the laser beam 22 only into the crack 7.

The local heating can also be effected by means of tunable microwaves. Tunable means that, inter alia, the wavelength and intensity can be varied.

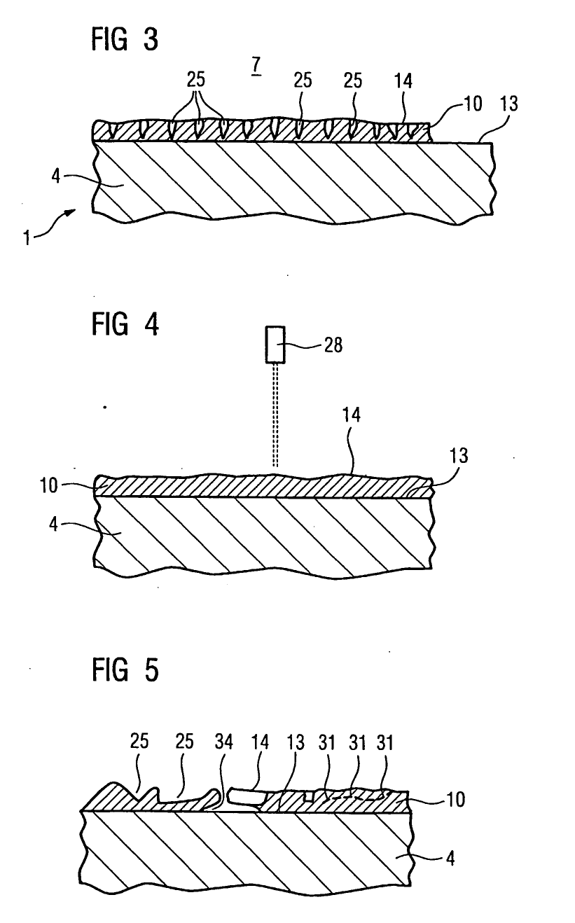

FIG. 3 shows a component 1 with a corrosion product 10 following the damaging of the corrosion product 10 by a pretreatment according to the invention.

The pretreatment produces cracks 25 which run from the surface 14 of the layer 10 in the direction of the substrate 4, resulting in a larger attackable surface area of the corrosion product 10 with respect to the acid and/or the fluoride ions, etc.

Cracks 25 of this type can also be produced by means of laser beams, high-pressure water jets, sand-blasting, in particular with coarse grains. The intensity and duration of the sand-blasting treatment, however, has to be set in such a way that the substrate 4 is not reached and the corrosion product 10 is only partially removed.

In a final process step, the component 1 is subjected to a final cleaning by means of an acid or fluoride ion treatment, which leads to complete removal of the corrosion product 10, since the damage to the corrosion product 10 means that the material-removal rate during FIC or another process is considerably increased and there is no significant reduction in the material-removal rate over the course of time.

FIG. 4 shows another way of damaging the corrosion product 10.

The corrosion product 10, which rests on a surface 13 of the substrate 4, is subjected to a thermal shock. The thermal shock can be effected by immersion in a hot metal or salt bath or by rapid heating by means of electron beams or a laser 28.

The corrosion product 10 may also be partially melted during the thermal shock.

FIG. 5 shows further damage to the corrosion product 10 in accordance with the process of the invention.

If the material of the corrosion product 10 has, for example, been melted, the material contracts again as it cools, resulting in mechanical stresses which can lead to crack formation.

In addition to cracks 25 in the surface of the corrosion product 10, it is also possible for cracks 31 to be produced within the corrosion product 10.

It is also possible for delaminations 34 to form between the corrosion product 10 and a surface 13 on which the corrosion product 10 rests.

The particular feature of the process is that the component 1 having the corrosion products 10, which has been damaged by these corrosion products 10 and needs to be repaired, is damaged still further in the region of the corrosion products 10.

FIG. 6 shows, by way of example, a partial longitudinal section through a gas turbine 100.

In the interior, the gas turbine 100 has a rotor 103 which is mounted such that it can rotate about an axis of rotation 102 and is also referred to as the turbine rotor.

An intake housing 104, a compressor 105, a, for example, toroidal combustion chamber 110, in particular an annular combustion chamber 106, with a plurality of coaxially arranged burners 107, a turbine 108 and the exhaust-gas housing 109 follow one another along the rotor 103.

The annular combustion chamber 106 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133. A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113.

From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield bricks which line the annular combustion chamber 106, are subject to the highest thermal stresses.

To be able to withstand the temperatures which prevail there, they have to be cooled by means of a coolant.

The substrates may likewise have a directional structure, i.e. they are in single-crystal form (SX structure) or have only longitudinally oriented grains (DS structure). Iron-base, nickel-base or cobalt-base superalloys are used as material.

It is also possible for the blades or vanes 120, 130 to have coatings which protect against corrosion (MCrAlX; M is at least one element selected from the group consisting of iron (Fe), cobalt (Co), nickel (Ni), X stands for yttrium (Y) and/or at least one rare earth element) and heat by means of a thermal barrier coating. The thermal barrier coating consists, for example, of ZrO₂, Y₂O₄—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Despite the protective layers, corrosion products 10 can form on the component. For refurbishment, the corrosion products have to be removed by the process according to the invention if the component is to be coated again. If appropriate, cracks in the substrate of the component are then repaired.

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

FIG. 7 shows a combustion chamber 110 of a gas turbine. The combustion chamber 110 is configured, for example, as what is known as an annular combustion chamber, in which a multiplicity of burners 102 arranged circumferentially around the turbine shaft 103 open out into a common combustion chamber space. For this purpose, the combustion chamber 110 overall is of annular configuration positioned around the turbine shaft 103.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155. On the working medium side, each heat shield element 155 is equipped with a particularly heat-resistant protective layer or is made from material that is able to withstand high temperatures. A cooling system is also provided for the heat shield elements 155 and/or their holding elements, on account of the high temperatures in the interior of the combustion chamber 110.

The materials of the combustion chamber wall and their coatings may be similar to the turbine blades or vanes 120, 130.

The combustion chamber 110 is designed in particular to detect losses of the heat shield elements 155. For this purpose, a number of temperature sensors 158 are positioned between the combustion chamber wall 153 and the heat shield elements 155.

FIG. 8 shows a perspective view of a blade or vane 120, 130, which extends along a longitudinal axis 121. The blade or vane 120, 130 has, in succession along the longitudinal axis 121, a securing region 400, an adjoining blade or vane platform 403 and a main blade or vane region 406. A blade or vane root 183, which is used to secure the rotor blades 120, 130 to the shaft, is formed in the securing region 400. The blade or vane root 183 is designed in hammerhead form. Other configurations, such as a fir-tree or dovetail root are possible. In the case of conventional blades or vanes 120, 130, solid metallic materials are used in all the regions 400, 403, 406 of the rotor blade 120, 130. The rotor blade 120, 130 may in this case be produced by a casting process, by a forging process, by a milling process or combinations thereof.

FIG. 9 illustrates, by way of example, a steam turbine 300, 303 with a turbine shaft 309 extending along an axis of rotation 306.

The steam turbine has a high-pressure part-turbine 300 and an intermediate-pressure part-turbine 303, each with an inner casing 312 and an outer casing 315 surrounding it. The high-pressure part-turbine 300 is, for example, of pot-type design. The intermediate-pressure part-turbine 303 is of two-flow design. It is also possible for the intermediate-pressure part-turbine 303 to be of single-flow design. Along the axis of rotation 306, a bearing 318 is arranged between the high-pressure part-turbine 300 and the intermediate-pressure part-turbine 303, the turbine shaft 309 having a bearing region 321 in the bearing 318. The turbine shaft 309 is mounted on a further bearing 324 next to the high-pressure part-turbine 300. In the region of this bearing 324, the high-pressure part-turbine 300 has a shaft seal 345. The turbine shaft 309 is sealed with respect to the outer casing 315 of the intermediate-pressure part-turbine 303 by two further shaft seals 345. Between a high-pressure steam inflow region 348 and a steam outlet region 351, the turbine shaft 309 in the high-pressure part-turbine 300 has the high-pressure rotor blading 354, 357. This high-pressure rotor blading 354, 357, together with the associated rotor blades (not shown in more detail), constitutes a first blading region 360. The intermediate-pressure part-turbine 303 has a central steam inflow region 333. Assigned to the steam inflow region 333, the turbine shaft 309 has a radially symmetrical shaft shield 363, a cover plate, on the one hand for dividing the flow of steam between the two flows of the intermediate-pressure part-turbine 303 and also for preventing direct contact between the hot steam and the turbine shaft 309. In the intermediate-pressure part-turbine 303, the turbine shaft 309 has a second blading region 366 comprising the intermediate-pressure rotor blades 354, 342. The hot steam flowing through the second blading region 366 flows out of the intermediate-pressure part-turbine 303 from an outflow connection piece 369 to a low-pressure part-turbine (not shown) which is connected downstream in terms of flow.

The components of the steam turbine 300, 303 likewise have protective layers and/or corrosion products 10 which are removed by the process according to the invention before the components can be refurbished.

1-26. (canceled)

27. A method for removing a removal region of a component, comprising:
pre-treating the removal region to damage the removal region and increase the material removal rate during a subsequent cleaning compared to a material removal rate without pre-treating the removal region;
damaging the removal region by an application selected from the group consisting of: a fused salt attack, sand blasting, thermal shock and acid treatment; and
cleaning the component to remove the damaged removal region material.

28. The method as claimed in claim 27, wherein the fused salt is sodium sulfate or cobalt sulfate.

29. The method as claimed in claim 27, wherein during the damaging step, cracks that damage the removal region are produced in the removal region.

30. The method as claimed in claim 27, wherein delaminations are produced between the removal region and a surface of the component.

31. The method as claimed in claim 27, wherein a slurry or a sheet material is applied to the removal region to damage the removal region.

32. The method as claimed in claim 27, wherein the removal region is heated.

33. The method as claimed in claim 32, wherein the heat provided to the removal region is in the form selected from the group consisting of: laser light, electro-magnetic induction, and microwave radiation.

34. The method as claimed in claim 27, wherein the process removes the corrosion products from the removal region selected from the group consisting of: aluminum oxide, cobalt oxide, and titanium oxide.

35. The method as claimed in claim 33, wherein the thermal shock is generated by at least partial melting and subsequent cooling of the removal region.

36. The method as claimed in claim 27, wherein the cleaning is a fluoride ion cleaning of the component.

37. The method as claimed in claim 27, wherein the removal region is located on a metallic substrate.

38. The method as claimed in claim 37, wherein the substrate is a nickel-base, cobalt-base or iron-base superalloy.

39. The method as claimed in claim 37, wherein the removal region is a layer that includes corrosion products.

40. The method as claimed in claim 37, wherein the removal region is metallic or ceramic.

41. The method as claimed in claim 40, wherein the removal region is a layer on an MCrAlX layer, where M stands for at least one element selected from the group consisting of iron, cobalt or nickel and X stands for yttrium and/or at least one rare earth element.

42. The method as claimed in claim 27, wherein the component is a previously operated gas or steam turbine rotor blade or guide vane or a combustion chamber lining.

43. A method for refurbishing a high temperature turbine component containing a corrosion product, comprising:
applying a fused salt to the surface of the component on the corrosion product to increase the material removal rate of the corrosion product area during a subsequent cleaning compared to a material removal rate without pre-treating the component; and
cleaning the component to remove the corrosion product.

44. The method as claimed in claim 43, wherein the fused salt is sodium sulfate or cobalt sulfate.

45. The method as claimed in claim 43, wherein the fused salt is applied to an area surrounding the corrosion product.

46. The method as claimed in claim 43, wherein the component is cleaned by a fluoride ion cleaning or an acid treatment.
